(19) United States
(12) Patent Application Publication
(10) Pub. No.: US 2015/0363797 A1
(43) Pub. Date: Dec. 17, 2015

(54) Vehicle Test System

(71) Applicant: Atieva, Inc., Redwood City, CA (US)

(72) Inventor: Vineeth Ramesh, Fremont, CA (US)

(73) Assignee: Atieva, Inc., Redwood City, CA (US)

(21) Appl. No.: 14/304,512

(22) Filed: Jun. 13, 2014

(51) Int. Cl. G06Q 30/02; G07C 5/08; H04W 4/04; G06Q 10/06; H04L 29/08

(52) U.S. Cl. CPC G06Q 30/0201; G06Q 10/0637; H04L 67/12; H04W 4/046; G07C 5/0841

(57) ABSTRACT

A method of using private vehicles for testing is provided, where the method includes the steps of (i) transmitting a request to users of the vehicle/technology to be tested, (ii) transmitting test protocols and/or software updates to users that accept the request to participate in the test, (iii) monitoring a set of vehicle performance characteristics during the test, (iv) transmitting a data log generated during the test for each participating user/vehicle, and (v) issuing participation rewards, such as a coupon for goods and services offered by the vehicle's manufacturer, to test participants.

### FIELD OF THE INVENTION

The present invention relates generally to a vehicle and, more particularly, to a system that provides a means for individual car owners to augment the vehicle development and testing program used by a vehicle manufacturer.

### BACKGROUND OF THE INVENTION

The research and development (R&D) program used by car manufacturers to develop a new model car can be quite extensive and time consuming, especially if the car under development represents a completely new model or is using a relatively new technology. Although there are many stages during this process, ranging from basic research to developing integration and manufacturing plans, typically one of the last R&D stages utilizes beta test vehicles to test new models and technology under real world conditions. Typically it is during the beta testing stage that minor and somewhat subtle modifications are made that may improve both the performance and the quality of the final product.

While the automobile industry's current approach to R&D provides a viable system for developing new car models and new car technologies, both the time and the cost associated with beta testing limits the degree to which this form of testing may be used. Accordingly, what is needed is a way in which the beta testing cycle can be increased, both in terms of the length of time as well as the number of test vehicles, while incurring minimal additional costs. The present invention provides a system that achieves these goals.

### SUMMARY OF THE INVENTION

The present invention provides a method of using private vehicles for testing, the method comprising the step of transmitting a test request for a particular vehicle test to a group of vehicle users, where the test request preferably includes a set of test parameters and a description of a participation reward, where for each vehicle user of the group of vehicle users that accepts the test request the method further comprises the steps of (i) transmitting a set of test protocols associated with the particular vehicle test, where the set of test protocols may include a vehicle software update; (ii) monitoring a set of vehicle performance characteristics during the particular vehicle test for each vehicle of a plurality of vehicles, where each vehicle of the plurality of vehicles corresponds to each vehicle user of the group of vehicle users that accepted the test request; (iii) transferring a data log of the set of vehicle performance characteristics for each vehicle of the plurality of vehicles, where the data log is preferably transferred after completion of the particular vehicle test; and (iv) issuing a participation reward to each vehicle user of the group of vehicle users that accepted the test request. The method may further include the step of selecting the group of vehicle users from a larger set of vehicle users based on a user characteristic such as geographic location, driver age, driver driving style or vehicle environmental conditions.

In one aspect, the steps of transmitting the test request, transmitting the set of test protocols and issuing the participation reward may be performed by a party selected from the group consisting of the vehicle manufacturer or the vehicle manufacturer's representative. Preferably each vehicle user is neither an employee of the vehicle manufacturer nor of the manufacturer's representative. Preferably each vehicle of the plurality of vehicles is neither owned by the vehicle manufacturer nor by the manufacturer's representative.

In another aspect, the step of transmitting the test request may further comprise the step of transmitting the test request wirelessly to a user interface incorporated into each vehicle; alternately, may further comprise the step of transmitting the test request wirelessly via an application installed on each of a plurality of user smartphones, where each user smartphone corresponds to each vehicle user.

In another aspect, incorporated into each vehicle may be a data logging system, where the step of monitoring the set of vehicle performance characteristics may further comprise the step of generating the data log from the set of vehicle performance characteristics during the particular vehicle test.

In another aspect, the step of transferring the data log may further comprise the step of transferring the data log to either a manufacturer of the vehicle or its representative.

In another aspect, the step of transferring the data log may further comprise the step of wirelessly transmitting the data log from each vehicle to a manufacturer of the vehicle or its representative. The step of wirelessly transmitting the data log may be performed in response to receiving a request for the data log, where the request for the data log is transmitted by the vehicle's manufacturer or its representative.

In another aspect, the step of transferring the data log may further comprise the step of downloading the data log, where the downloading may be performed at a service center, for example a service center operated by the manufacturer of the vehicle or its representative.

In another aspect, the step of issuing the participation reward may further comprise issuing a redeemable participation reward, wherein the redeemable participation reward is redeemable for goods and services offered by the manufacturer of the vehicle or its representative.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 illustrates a communication system for use with the invention;

FIG. 2 illustrates the basic methodology of the invention in accordance with a preferred embodiment;

FIG. 3 illustrates a modification of the basic methodology shown in FIG. 2; and

FIG. 4 provides a system level diagram of the primary systems utilized in at least one embodiment of the invention.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure. The terms “electric vehicle” and “EV” may be used interchangeably and refer to an all-electric vehicle.

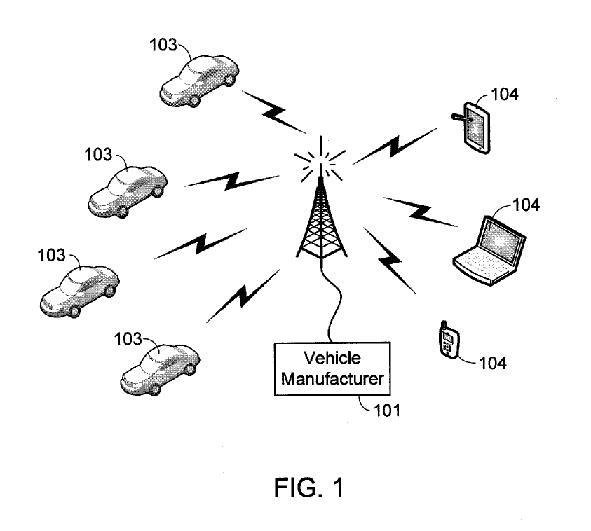

In accordance with the invention, and as illustrated in FIG. 1, vehicle manufacturer 101, or a party working on the behalf of the manufacturer, is able to wirelessly communicate with a plurality of users 103 and 104, where each user owns, or leases, or otherwise drives one of the manufacturer's vehicles. As described in further detail below, the system may be configured to allow wireless communication between each user and the manufacturer 101 via a user interface integrated into vehicles 103, and/or to allow wireless communication between each user and the manufacturer 101 via an application installed on a user device 104 (e.g., smartphone, tablet, laptop, computer, etc.).

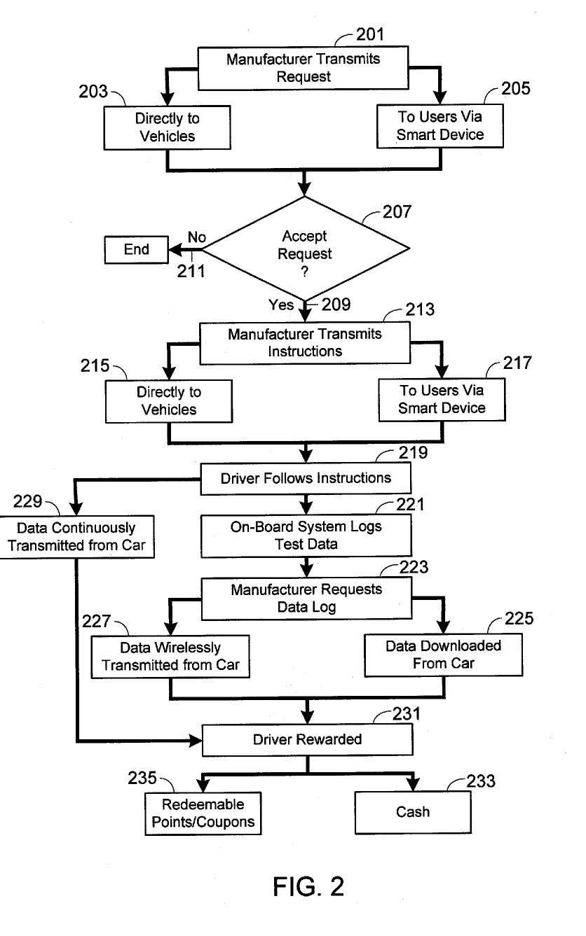

FIG. 2 illustrates the methodology associated with one embodiment of the invention. Initially the manufacturer, or a party working on behalf of the manufacturer, transmits a request to users of the vehicle/technology to be tested, or to a group of the users of the vehicle/technology to be tested (step 201). Depending upon the configuration of the system, as well as the communication capabilities of the vehicles in question, this request may be transmitted directly to vehicles 103 (step 203), or to users 104 (step 205), or both. Preferably, the requesting party 101 provides a very brief description of the requirements associated with the request as well as the rewards, discussed below, if the user accepts the request to participate in the program. Depending upon the purpose of the test, party 101 may transmit the request to all users of the vehicle/technology in question in order to have as many users as possible accept the request, thereby providing not only a large amount of data, but also data taken from vehicles under a wide range of conditions, e.g., different environmental conditions, different driver age groups, different driving styles, etc. Alternately, party 101 may only transmit the request to a pre-selected group of users in order to test the new protocol, software, etc. with vehicles driven under certain environmental conditions (e.g., very hot temperatures so group tailored to residents living in higher temperature regions such as Arizona, or very cold temperatures so group tailored to residents living in colder regions such as the northeast corridor, etc.), or driven by a certain type of driver (e.g., specific age group, very aggressive or very conservative drivers, etc.). Alternately, party 101 may only transmit the request to a small, but random group of users in order to minimize the number of drivers affected by the test, and/or limit the extent of participation rewards required in order to perform the test.

In step 207, the user has the option to either agree to accept the request (step 209) or not (step 211). If the user agrees to accept the request (step 209), then a set of instructions are sent to the user (step 213). Depending upon the communication capabilities of the vehicles to be tested, and in some instances depending upon the communication protocols in place (e.g., communication protocols required by the manufacturer or user), the instructions may be transmitted to vehicles 103 (step 215), or to users 104 (step 217), or both.

In a typical request, the user may be required to drive in a certain fashion in order to test a new driving protocol to determine the new protocol's efficacy or to determine whether the new driving protocol provides sufficient benefit to justify its adoption by the vehicle manufacturer. For example, in an EV the test may require that prior to driving the vehicle, the user thermally pre-condition the vehicle's battery pack to a predetermined temperature range using the on-board thermal management system, possibly to determine thermal conditioning requirements, or the effects of battery pack thermal conditioning on range, or the willingness of drivers to utilize thermal conditioning, etc. Alternately, drivers who accept the manufacturer's request may be required to adhere to a certain driving style (e.g., aggressive accelerating/braking, conservative acceleration/braking, limits on top speed, etc.) or passenger comfort (e.g., allowed temperature differential between cabin temperature and the ambient environment, etc.) in order to determine the effects on vehicle range or performance.

After the instructions have been sent to the driver, either via the car's user interface (step 215) or the user's smart device (step 217), the driver simply follows the instructions (step 219). Preferably as long as the test is underway, which may extend over the course of hours, days, weeks, or months, the vehicle logs data (step 221) that can be used to determine the effects of the new driving protocol. For example, the system may utilize speed sensors and accelerometers in order to determine how hard the vehicle is being driven; environmental sensors (e.g., a global positioning system (GPS), altimeter, barometer, temperature sensor, precipitation and/or humidity sensor, etc.) to monitor the vehicle's environment as it is being driven; and if the vehicle is an EV, then sensors may be used to monitor various battery pack characteristics (e.g., current state-of-charge, rate of discharge, battery pack temperature, etc.).

After the test concludes, or in some instances at intervals throughout the test, the manufacturer or its representative will request the data log from the vehicles under test (step 223). In some vehicle configurations the data must be downloaded from the vehicle (step 225), for example when the vehicle is at a service center, while in other configurations the data is wirelessly transmitted by the car to the manufacturer or its representative (step 227). It should be understood that if the vehicle has wireless communication capabilities, as preferred, the system may also be configured to continuously transmit data from the car to the manufacturer (step 229), or at least when the car is being driven. Typically, however, it is preferable to store data on-board and only periodically download the data logs (e.g., either step 225 or step 227).

Once the test has concluded and the manufacturer, or its representative, has downloaded the data and confirmed compliance by the user in question, then the user is issued a participation reward (step 231) per the original offer made in step 201. Although a cash award may be given (step 233), preferably the user is issued a coupon or given a certain number of points (step 235) that may be applied towards various items or services, and more preferably towards various items and/or services offered by the manufacturer through its service centers or dealers (e.g., floor mats, logo branded clothes, coffee mugs, car wash, car detailing, oil change, vehicle check-up, etc.).

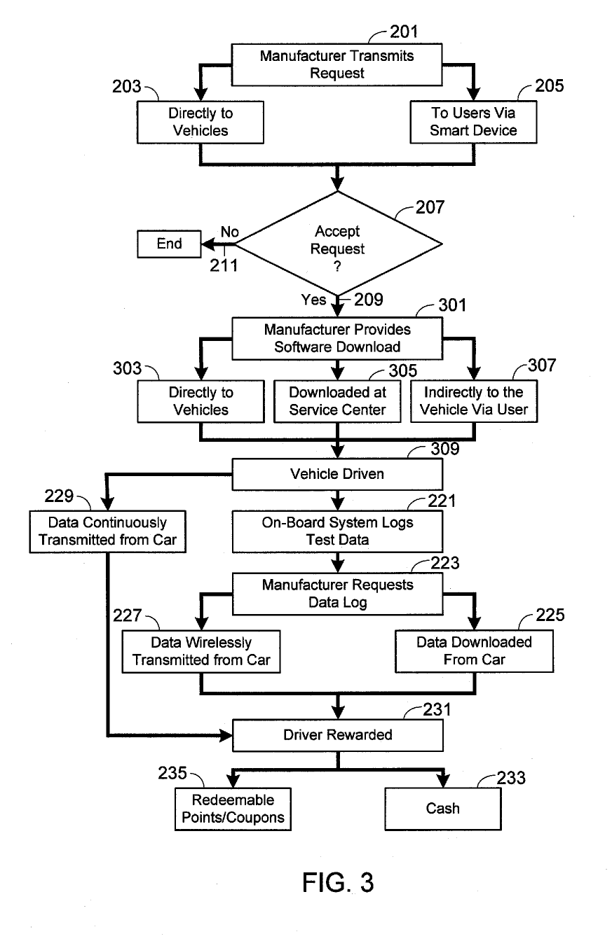

In addition to requesting that the users, or a group of users, follow a certain driving protocol, the manufacturer or its representative may also request that the users download and test new software (e.g., a software update) that controls some aspect of the vehicle's functionality (e.g., thermal management system, battery pack control system for an EV, modified user interface, etc.). This aspect of the invention is illustrated in FIG. 3. As shown, once a request is issued (step 201) and accepted (step 209), then the manufacturer provides the new software to be tested (step 301). Preferably the software is downloaded directly to the vehicle (step 303) using a wireless link. Alternately, the user may be required to go to a service center, vehicle dealership or other location in order to have the software downloaded to their vehicle (step 305). Alternately, the software may be provided to the user so that the user can download the software to the vehicle (step 307). For example, the software may be mailed or couriered to the user on a flash drive; alternately, the software may be emailed or otherwise forwarded to a user device (e.g., computer), allowing the user to download the software from their device to a flash drive or similar memory, and then downloaded from the flash drive to the user's vehicle.

Once the software/software update is downloaded to the user's vehicle, preferably the vehicle is driven like normal although some software updates may require that the driver follow a certain protocol (step 309). From this point on, the system logs data and provides that data to the manufacturer or its representative in exchange for participation rewards as shown, and as described above relative to the method illustrated in FIG. 2.

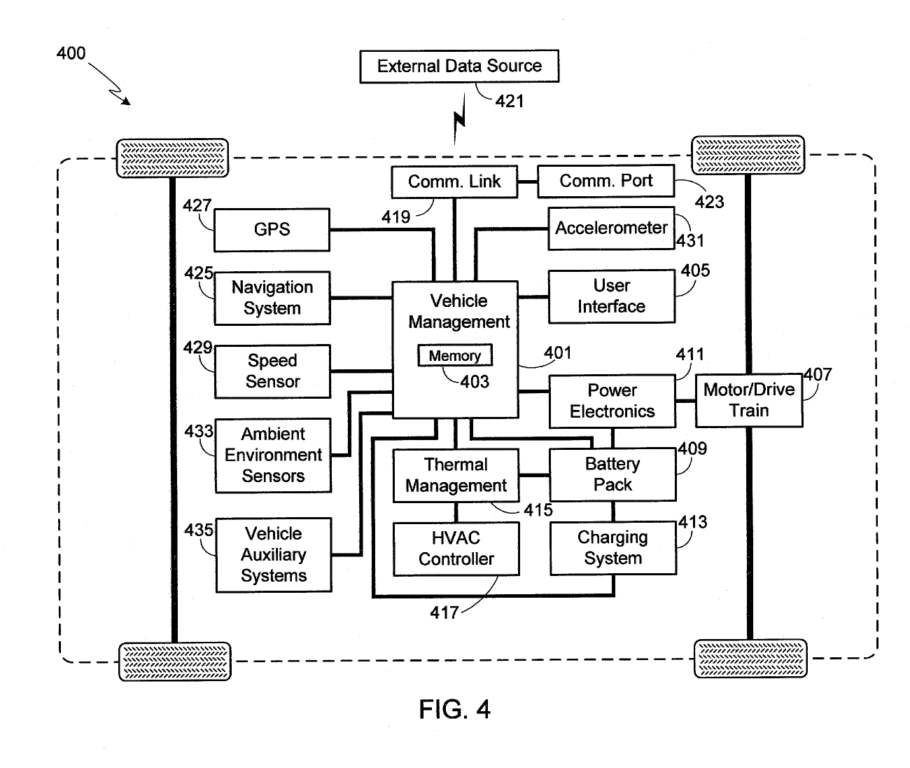

FIG. 4 is a high-level view of an EV 400 and the primary systems used in a vehicle test system in accordance with the invention. It should be understood that although the system of the invention is illustrated with an EV, it is equally suited for use with a vehicle utilizing an internal combustion engine (ICE), or with a hybrid vehicle, where a hybrid vehicle utilizes multiple sources of propulsion including an electric drive system.

Vehicle 400 includes a vehicle system controller 401, also referred to as a vehicle management system, which is comprised of a central processing unit (CPU). System controller 401 also includes memory 403, with memory 403 being comprised of EPROM, EEPROM, flash memory, RAM, solid state drive, hard disk drive, or any other type of memory or combination of memory types. In addition to other tasks, memory 403 is used in at least one preferred configuration of the invention to store, i.e., log, the test data when the user is participating in a driving protocol, software update, or other test. Memory 403 may also be used to store the software used by vehicle 400 to operate the various vehicle subsystems.

Coupled to the vehicle system controller 401 is a user interface 405. Interface 405 allows the driver, or a passenger, to interact with the vehicle management system, for example inputting data into the navigation system, altering the heating, ventilation and air conditioning (HVAC) system, controlling the vehicle's entertainment system (e.g., radio, CD/DVD player, etc.), adjusting vehicle settings (e.g., seat positions, light controls, etc.), and/or otherwise altering the functionality of vehicle 400. In at least some embodiments, interface 405 also includes means for the vehicle management system to provide information to the driver and/or passenger, information such as a navigation map or driving instructions as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed, current HVAC settings such as cabin temperature and/or fan settings, etc.). Interface 405 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Preferably interface 405 is also used to transmit testing requests, test parameters, driving protocols, data download requests, etc. to the user. Interface 405 may be comprised of a single interface, for example a touch-screen display, or a combination of user interfaces such as push-button switches, capacitive switches, slide or toggle switches, gauges, display screens, warning lights, audible warning signals, etc. It will be appreciated that if user interface 405 includes a graphical display, controller 401 may also include a graphical processing unit (GPU), with the GPU being either separate from or contained on the same chip set as the CPU.

Vehicle 400 includes one or more motors 407 that provide vehicle propulsion, although as previously noted the invention is equally applicable to ICE-based or hybrid vehicles in which case motor(s) 407 would be replaced with an internal combustion engine or a hybrid drive train. The vehicle's drive system (e.g., motor 407) may be mechanically coupled to the front axle/wheels, the rear axle/wheels, or both, and may utilize any of a variety of transmission types (e.g., single speed, multi-speed) and differential types (e.g., open, locked, limited slip). Assuming that vehicle 400 is an EV as shown, the vehicle includes a battery pack 409, which may be comprised of one or hundreds or thousands of rechargeable batteries, that supplies the power necessary for operation of motor(s) 407. Additionally, battery pack 409 may provide the power necessary for the various vehicle systems that require electrical power (e.g., lights, entertainment systems, navigation system, etc.). Typically battery pack 409 is coupled to motor(s) 407 via a power control system 411 that insures that the power delivered to the drive motor is of the proper form (e.g., correct voltage, current, waveform, etc.). Battery pack 409 is charged by charging system 413, which may either be integrated into the vehicle as shown, or be comprised of an external charging system. Typically charging system 413 is configured to be electrically connected to an external power source, not shown, such as the municipal power grid. Battery pack 409 may also be charged, at least in part, using an on-board system such as a regenerative braking system.

Vehicle 400 includes a thermal management system 415 that includes both a heating subsystem and a cooling subsystem. Thermal management system 415 is coupled to the HVAC system controller 417 used to maintain the passenger cabin within the desired temperature range. Assuming vehicle 400 is an EV as shown, thermal management system 415 is also used to insure that the batteries within battery pack 409 are maintained within the desired operating, charging and/or storage temperature range.

Coupled to vehicle management system 401 is a communication link 419. Communication link 419 may be used to wirelessly receive manufacturer requests, receive manufacturer test instructions, receive software updates or other information from an external data source 421 (e.g., manufacturer, dealer, service center, web-based application, remote home-based system, third party source, etc.) using any of a variety of different technologies (e.g., GSM, EDGE, UMTS, CDMA, DECT, WiFi, WiMax, etc.). Communication link 419 may also be used to transmit information, data, and data logs from the vehicle to the manufacturer or its representative. In some embodiments, communication link 419 may also include an on-board port 423, such as a USB, Thunderbolt, or other port. Port 423 may be used to receive updates and/or other information from the vehicle's manufacturer (or its representative) over a wired communication link, or to transmit data/data logs from the vehicle to the vehicle's manufacturer or its representative.

A variety of subsystems and sensors may be coupled to vehicle management system 401 for use by the driver and/or passengers for routine vehicle operation (e.g., audio system, light controls, windshield wiper controls, etc.). At least some of the subsystems and sensors coupled to vehicle management system 401 are also used when performing the requested vehicle tests or following the requested driving protocols. For example, navigation system 425 and GPS 427 may be used both during routine vehicle operation and in some test protocols to track the location of vehicle 400. In order to track vehicle performance, both routinely and during testing, the system may include a speed sensor 429 and, in at least some embodiments, an accelerometer 431. The system may also include a variety of ambient environmental sensors 433 in order to monitor external conditions as well as provide useful information during testing (e.g., temperature sensor(s), humidity sensor(s), precipitation sensor(s), elevation sensor(s), etc.). Various auxiliary systems 435 may also be coupled to vehicle management system 401, thereby providing additional information about the vehicle's performance during testing and normal use (e.g., vehicle suspension system, battery pack sensors, motor/engine speed sensors).

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A method of utilizing private vehicles for testing, the method comprising the steps of:
transmitting a test request for a particular vehicle test to a group of vehicle users, wherein for each vehicle user of said group of vehicle users that accepts said test request said method further comprises the steps of;
transmitting a set of test protocols associated with said particular vehicle test;
monitoring a set of vehicle performance characteristics during said particular vehicle test for each vehicle of a plurality of vehicles, wherein each vehicle of said plurality of vehicles corresponds to each vehicle user of said group of vehicle users that accepted said test request;
transferring a data log of said set of vehicle performance characteristics for each vehicle of said plurality of vehicles; and
issuing a participation reward to each vehicle user of said group of vehicle users that accepted said test request.

2. The method of claim 1, wherein said steps of transmitting said test request, transmitting said set of test protocols and issuing said participation reward are performed by a party selected from the group consisting of a vehicle manufacturer or a vehicle manufacturer's representative.

3. The method of claim 2, wherein each vehicle user is neither an employee of said vehicle manufacturer nor an employee of said vehicle manufacturer's representative.

4. The method of claim 1, wherein said plurality of vehicles are neither owned by said vehicle manufacturer nor by said vehicle manufacturer's representative.

5. The method of claim 1, wherein said test request is comprised of a set of test parameters and a description of said participation reward.

6. The method of claim 1, wherein said step of transmitting said set of test protocols further comprises the step of transmitting a vehicle software update.

7. The method of claim 1, wherein said step of transmitting said test request further comprises the step of transmitting said test request wirelessly to a user interface incorporated into each vehicle of said plurality of vehicles.

8. The method of claim 1, wherein said step of transmitting said test request further comprises the step of transmitting said test request wirelessly via an application installed on each of a plurality of user smartphones, wherein each user smartphone of said plurality of user smartphones corresponds to each vehicle user of said group of vehicle users.

9. The method of claim 1, wherein a data logging system is incorporated into each vehicle of said plurality of vehicles, and wherein said step of monitoring said set of vehicle performance characteristics further comprises the step of generating said data log from said set of vehicle performance characteristics during said particular vehicle test.

10. The method of claim 1, wherein said step of transferring said data log further comprises the step of transferring said data log to either a manufacturer of said vehicle or a representative of said manufacturer of said vehicle.

11. The method of claim 1, wherein said step of transferring said data log further comprises the step of wirelessly transmitting said data log from each vehicle of said plurality of vehicles to a manufacturer of said vehicle or a representative of said manufacturer of said vehicle.

12. The method of claim 11, wherein said step of wirelessly transmitting said data log is performed in response to the step of receiving a request for said data log, wherein said request for said data log is transmitted by said manufacturer or said representative of said manufacturer to each vehicle user of said group of vehicle users that accepted said test request.

13. The method of claim 1, wherein said step of transferring said data log further comprises the step of downloading said data log.

14. The method of claim 13, wherein said step of downloading said data log is performed at a service center.

15. The method of claim 14, wherein said service center is operated by a manufacturer of said vehicle or a representative of said manufacturer of said vehicle.

16. The method of claim 1, said step of issuing said participation reward further comprising the steps of confirming compliance of each vehicle user of said group of vehicle users that accepted said test request with said set of test protocols, and issuing said participation reward to each vehicle user of said group of vehicle users that accepted said test request and that complied with said set of test protocols.

17. The method of claim 1, said step of issuing said participation reward further comprising issuing a redeemable participation reward, wherein said redeemable participation reward is redeemable for goods and services offered by a manufacturer of said vehicle or a representative of said manufacturer of said vehicle.

18. The method of claim 1, wherein said step of transferring said data log is performed after completion of said particular vehicle test.

19. The method of claim 1, further comprising the step of selecting said group of vehicle users from a larger set of vehicle users based on a user characteristic.

20. The method of claim 19, wherein said user characteristic is selected from the group consisting of geographic location, driver age, driver driving style, and vehicle environmental conditions.
